(19) United States
(12) Patent Application Publication
(10) Pub. No.: US 2023/0339616 A1
(43) Pub. Date: Oct. 26, 2023

(54) ENVIRONMENTAL CONTROL SYSTEM WITH AIR POWERED PUMP

(71) Applicant: Hamilton Sundstrand Corporation, Charlotte, NC (US)

(72) Inventor: Alan Retersdorf, Avon, CT (US)

(21) Appl. No.: 17/725,052

(22) Filed: Apr. 20, 2022

(51) Int. Cl. B64D 13/06

(52) U.S. Cl. CPC B64D 13/06; B64D 2013/0618; B64D 2013/064; F28F 2250/08; B60H 1/00328

(57) ABSTRACT

An environmental control system of a vehicle includes an inlet configured to receive a medium, a heat exchanger fluidly connected to the inlet to receive the medium, and a ram air circuit including another inlet configured to receive ram air and including a ram air heat exchanger. A closed secondary fluid loop is operably coupled to the heat exchanger and to the ram air heat exchanger. The secondary fluid loop has a secondary fluid circulating therein that removes heat from the medium in the heat exchanger and that discharges heat to the ram air in the ram air heat exchanger.

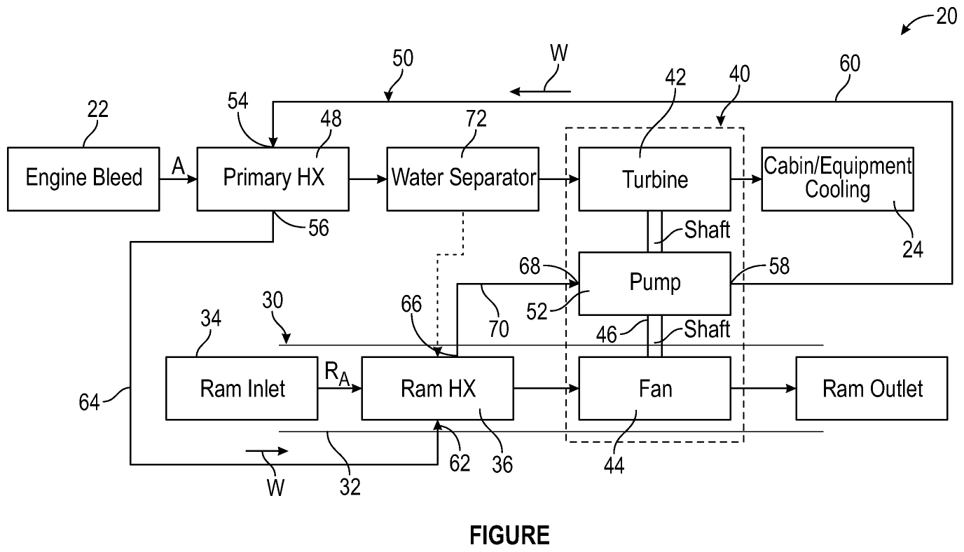

### BACKGROUND

Embodiments of the present disclosure relate to an environmental control system for an aircraft, and more particularly, to an environmental control system including a pump driven by an air flow.

Aircraft that fly at altitudes above that at which ambient air is suitable for the health and comfort of crew and passengers are often equipped with environmental air conditioning systems. Such systems provide pressurized conditioned air for cooling passengers, crew, and other aircraft systems and components. These air conditioning systems typically use high pressure air bled from a turbine engine or auxiliary power unit (APU). This high-pressure air is typically at a temperature and pressure far in excess of the temperature and pressure required for conditioned air to be supplied to the cockpit and passenger cabin, so it must be expanded and cooled by the air conditioning system before it can be discharged into the aircraft cabin as conditioned air.

The high-pressure air bled from a turbine engine or auxiliary power unit is typically cooled within the air conditioning system by rejecting heat therefrom directly to a ram air circuit. However, the use of engine bleed air increases the overall fuel burn of the system and ram air heat exchangers typically must be large to provide an acceptable heat sink for cooling the bleed air.

### BRIEF DESCRIPTION

According to an embodiment, an environmental control system of a vehicle includes an inlet configured to receive a medium, a heat exchanger fluidly connected to the inlet to receive the medium, and a ram air circuit including another inlet configured to receive ram air and including a ram air heat exchanger. A closed secondary fluid loop is operably coupled to the heat exchanger and to the ram air heat exchanger. The secondary fluid loop has a secondary fluid circulating therein that removes heat from the medium in the heat exchanger and that discharges heat to the ram air in the ram air heat exchanger.

In addition to one or more of the features described herein, or as an alternative, in further embodiments the secondary fluid is a liquid.

In addition to one or more of the features described herein, or as an alternative, in further embodiments the secondary fluid is water.

In addition to one or more of the features described herein, or as an alternative, in further embodiments comprising an expansion device, the expansion device being operably coupled to the heat exchanger and to the ram air circuit.

In addition to one or more of the features described herein, or as an alternative, in further embodiments the expansion device further comprises a turbine and a fan operably coupled by a shaft, the turbine being arranged to receive the medium from the heat exchanger, and the fan being arranged within the ram air circuit.

In addition to one or more of the features described herein, or as an alternative, in further embodiments the expansion device further comprises a pump mounted to the shaft, the pump being arranged within the secondary fluid loop, wherein work extracted by the turbine is transferred to the pump via the shaft.

In addition to one or more of the features described herein, or as an alternative, in further embodiments comprising a water extractor arranged directly downstream from the heat exchanger relative to a flow of the medium.

In addition to one or more of the features described herein, or as an alternative, in further embodiments the ram air is not arranged in a direct heat exchange relationship with the medium.

In addition to one or more of the features described herein, or as an alternative, in further embodiments the medium is bleed air.

In addition to one or more of the features described herein, or as an alternative, in further embodiments the vehicle is an aircraft.

According to an embodiment, a method of operating an environmental control system of a vehicle includes receiving a medium for delivery to one or more loads at a heat exchanger, circulating a secondary fluid within a secondary fluid loop operably coupled to the heat exchanger and a ram air circuit, cooling the medium by removing heat from the medium via the secondary fluid at the heat exchanger, and discharging heat from the secondary fluid to a ram air within the ram air circuit.

In addition to one or more of the features described herein, or as an alternative, in further embodiments comprising extracting energy from the medium and driving a pump using the energy extracted from the medium, the circulating of the secondary fluid being performed by the pump.

In addition to one or more of the features described herein, or as an alternative, in further embodiments comprising extracting energy from the medium; and driving a fan arranged within the ram air circuit using the energy extracted from the medium.

In addition to one or more of the features described herein, or as an alternative, in further embodiments comprising moving the ram air through the ram air circuit in response to driving the fan.

In addition to one or more of the features described herein, or as an alternative, in further embodiments comprising removing water from the medium after the removing heat from the medium at the heat exchanger.

In addition to one or more of the features described herein, or as an alternative, in further embodiments the secondary fluid is a liquid.

In addition to one or more of the features described herein, or as an alternative, in further embodiments the secondary fluid is water.

In addition to one or more of the features described herein, or as an alternative, in further embodiments the medium is bleed air.

In addition to one or more of the features described herein, or as an alternative, in further embodiments the vehicle is an aircraft.

### BRIEF DESCRIPTION OF THE DRAWINGS

The following descriptions should not be considered limiting in any way. With reference to the accompanying drawings, like elements are numbered alike:

The FIGURE is a schematic diagram of an environmental control system of a vehicle according to an embodiment.

### DETAILED DESCRIPTION

A detailed description of one or more embodiments of the disclosed apparatus and method are presented herein by way of exemplification and not limitation with reference to the FIGURE.

With reference now to the FIGURE, a schematic diagram of an embodiment a portion of an environmental control system (ECS) 20, such as an air conditioning unit or pack for example, is depicted according to a non-limiting embodiment. Although the environmental control system 20 is described with reference to an aircraft, alternative applications, such as another vehicle for example, are also within the scope of the disclosure. As shown, the ECS 20 may be configured to receive a medium A at an inlet 22 and provide a conditioned form of the medium A to one or more loads 24. In embodiments where the ECS 20 is used in an aircraft application, the medium A may be bleed air, which is pressurized air originating from, i.e., being “bled” from, an engine or auxiliary power unit of the aircraft. It shall be understood that one or more of the temperature, humidity, and pressure of the bleed air can vary based upon the compressor stage and revolutions per minute of the engine or auxiliary power unit from which the air is drawn.

As shown, the environmental control system 20 may include a ram air circuit 30 including a shell or duct 32 within which one or more heat exchangers are located. The ram air duct 32 can receive a medium RA, such as ram air for example, at an inlet 34 and can direct the medium RA through a portion of the ECS 20. The ram air RA may be ambient air from outside the aircraft. The one or more heat exchangers are devices built for efficient heat transfer from one medium to another. Examples of the type of heat exchangers that may be used, include, but are not limited to, double pipe, shell and tube, plate, plate and shell, adiabatic shell, plate fin, pillow plate, and fluid heat exchangers.

The one or more heat exchangers arranged within the ram air duct 32 may be referred to as ram heat exchangers. In the illustrated, non-limiting embodiment, the ram air circuit 30 includes a single heat exchanger 36. However, embodiments having additional ram air heat exchangers are also contemplated herein. Within the ram air heat exchanger 36, ram air RA, such as outside air for example, acts as a heat sink to cool another medium passing there through.

The ECS 20 additionally includes an expansion device 40. The expansion device 40 of the ECS 20 is a mechanical device that includes components for performing thermodynamic work on one or more mediums (e.g., extracts work from or applies work to a medium A by raising and/or lowering pressure and by raising and/or lowering temperature). Examples of the expansion device 40 include, but are not limited to, an air cycle machine, such as a three-wheel or four-wheel air cycle machine. In the illustrated, non-limiting embodiment, the compression device is a simple cycle or two-wheel air cycle machine.

As shown, the expansion device 40 includes a turbine 42 and a fan 44 operably coupled to one another via a shaft 46. The turbine 42 is a mechanical device that expands a medium and extracts work therefrom (also referred to as extracting energy). In the expansion device 40, the turbine 42 drives the fan 44 via the shaft 46. A fan 44 is a mechanical device that can force via push or pull methods air through the ram air duct 32, across at least a portion of one or more ram air heat exchangers 36. However, embodiments where the fan 44 is a component separate from the expansion device and is driven by any suitable means are also contemplated herein.

The ECS 20 additionally includes one or more heat exchangers or devices configured to provide efficient heat transfer from one medium to another. In the illustrated, non-limiting embodiment, the ECS 20 includes a single heat exchanger 48 arranged directly downstream from the inlet 22 of the medium A. However, embodiments including additional heat exchangers or other components at any suitable location relative to the flow of medium A or the flow of ram air RA are also within the scope of the disclosure.

In the illustrated, non-limiting embodiment, the ram air RA is not arranged in a direct heat exchange relationship with the medium A at either the heat exchanger 48 or the ram air heat exchanger 36. Rather, the ECS 20 uses a secondary fluid W circulating through a closed secondary fluid loop 50 to condition both the medium A and the ram air RA. In an embodiment, the secondary fluid W is a liquid, such as water or another suitable liquid for example. A pump 52 may be used to circulate the secondary fluid W through the secondary fluid loop 50. In an embodiment, the pump is 52 mounted to the shaft 46 of the expansion device 40 as a third wheel and is therefore driven by rotation of the shaft 46 resulting from work or energy extracted from the medium A within the turbine 42.

The secondary fluid loop 50 is thermally coupled to both the heat exchanger 48 and the ram air heat exchanger 36. In the illustrated, non-limiting embodiment, the heat exchanger 48 includes a secondary fluid inlet 54 and a secondary fluid outlet 56. The secondary fluid inlet 54 may be connected to an outlet 58 of the pump 52 by a conduit 60. Similarly, the ram air heat exchanger 36 includes a secondary fluid inlet 62 connected to the secondary fluid outlet 56 of the heat exchanger 48 by a conduit 64. The secondary fluid outlet 66 of the ram air heat exchanger 36 is fluidly coupled to an inlet 68 of the pump 52 by a conduit 70.

In operation, the medium A is provided to the ECS 20 via the inlet 22. From the inlet 22, the medium A is delivered to the heat exchanger 48. Within the heat exchanger 48, heat transfers from the medium A to the secondary fluid W. The resulting cooled medium A may then be provided to a downstream water separator or extractor 72. In an embodiment, the heat exchanger 48 is configured as a condenser such that as the medium A cools therein, the water entrained within the medium A will condense. This condensed fluid may then be removed from the medium A within the water extractor 72. The condensed fluid, for example water, removed from the medium A may be reused elsewhere on the aircraft. In the illustrated, non-limiting embodiment, the water is sprayed on the face of the ram air heat exchanger 36.

From the water extractor 72, the dry medium A is provided to an inlet of the turbine 42. Within the turbine 42, the medium A is expanded, and work is extracted therefrom which results in a cooling and depressurization of the medium A. The cooler and lower pressure medium A provided at an outlet of the turbine 42 may then be delivered to one or more loads of the vehicle.

The work extracted from the medium A within the turbine 42, drives the pump 52 causing the secondary fluid W to circulate within the secondary fluid loop 50. The work extracted form the medium A within the turbine 42 also drives rotation of the fan 44. As a result of this rotation of the fan 44, ram air RA from the inlet 26 moves through the ram air duct 32, and specifically, across the ram air heat exchanger 36. As previously noted, the heated secondary fluid W output from the heat exchanger 48 is provided to the secondary fluid inlet 62 of the ram air heat exchanger 36. Accordingly, within the ram air heat exchanger 36, heat from the secondary fluid W is transferred to the ram air RA. The heated ram air RA is then exhausted overboard from an outlet of the ram air duct 32.

An environmental control system 20 as described herein relies on a secondary fluid to remove heat from the medium A and then discharge that heat to the flow of ram air RA. Because the ability to transfer heat is significantly increased in liquid-air heat exchangers compared to air-air heat exchangers, inclusion of the secondary fluid loop results not only in an improved ability to discharge heat to the ram air RA, but also the potential to achieve cooler air temperatures at the outlet of the heat exchanger 48. Additionally, the energy required to increase a fluid's pressure via a pump is significantly less than required to increase the pressure of a gaseous medium (such as air) via a compressor which may allow for heat exchanger designs with more heat transfer surface area on the liquid sides relative to an air-air heat exchanger.

The term “about” is intended to include the degree of error associated with measurement of the particular quantity based upon the equipment available at the time of filing the application.

The terminology used herein is for the purpose of describing embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. An environmental control system of a vehicle comprising:
an inlet configured to receive a medium;
a heat exchanger fluidly connected to the inlet to receive the medium;
a ram air circuit including another inlet configured to receive ram air and including a ram air heat exchanger; and
a closed secondary fluid loop operably coupled to the heat exchanger and to the ram air heat exchanger, the secondary fluid loop having a secondary fluid circulating therein that removes heat from the medium in the heat exchanger and that discharges heat to the ram air in the ram air heat exchanger.

2. The environmental control system of claim 1, wherein the secondary fluid is a liquid.

3. The environmental control system of claim 2, wherein the secondary fluid is water.

4. The environmental control system of claim 1, further comprising an expansion device, the expansion device being operably coupled to the heat exchanger and to the ram air circuit.

5. The environmental control system of claim 4, wherein the expansion device further comprises a turbine and a fan operably coupled by a shaft, the turbine being arranged to receive the medium from the heat exchanger, and the fan being arranged within the ram air circuit.

6. The environmental control system of claim 5, wherein the expansion device further comprises a pump mounted to the shaft, the pump being arranged within the secondary fluid loop, wherein work extracted by the turbine is transferred to the pump via the shaft.

7. The environmental control system of claim 1, further comprising a water extractor arranged directly downstream from the heat exchanger relative to a flow of the medium.

8. The environmental control system of claim 1, wherein the ram air is not arranged in a direct heat exchange relationship with the medium.

9. The environmental control system of claim 1, wherein the medium is bleed air.

10. The environmental control system of claim 1, wherein the vehicle is an aircraft.

11. (canceled)

12. (canceled)

13. (canceled)

14. (canceled)

15. (canceled)

16. (canceled)

17. (canceled)

18. (canceled)

19. (canceled)
